(19) United States
(12) Patent Application Publication
(10) Pub. No.: US 2003/0197889 A1
(43) Pub. Date: Oct. 23, 2003

(54) Document management device and recording medium recoding document management program

(75) Inventor: Yoshifumi Tanimoto, Osaka (JP)

Correspondence Address: ARMSTRONG,WESTERMAN & HATTORI, LLP, 1725 K STREET, NW, SUITE 1000, WASHINGTON, DC, 20006, US

(73) Assignee: MURATA KIKAI KABUSHIKI KAISHA, kyoto-shi (JP)

(21) Appl. No.: 10/410,253

(22) Filed: Apr. 10, 2003

(30) Foreign Application Priority Data
Apr. 18, 2002 (JP) 2002-116426

(51) Int. Cl. G06F 15/00; H04N 1/32

(52) U.S. Cl. 358/1.15; 358/404; 358/468; 358/402

(57) ABSTRACT

A facsimile server includes a document management device which includes an event setting table, an event detecting unit, and en event processing unit. The event setting table defines a generation condition for several types of events that generate in the facsimile server, a destination of notification to a remote device, a communication unit, a message and other processing. The event detecting unit detects a generation of the event. When the event occurs, for example, when receiving a facsimile or when the memory overflow occurs, a prescribed message is notified by a prescribed communication unit to a destination which are defined in the event setting table. In addition, other processing such as a list printing, or printing of a received original is executed. Appropriate processing can be defined freely and precisely for various events that generate in the facsimile server or the like.

### FIELD OF THE INVENTION

The present invention relates to a document management device and a recording medium recording a document management program. In particular, the present invention relates to a document management device and a recording medium recording a document management program that grasps an event relating to a communication or an event relating to a document to be managed as an event, and which notify a generation of the event to a remote device.

2. Description of the Related Art

In a facsimile server, a document management server or the like, the event such as a reception of data or an access to a data (document) being managed occurs frequently. Since there are many cases in which these servers are used by being connected to a Local Area Network (LAN) or the like, it becomes necessary to notify the generation of the event to a remote device. Therefore, it is necessary to define precisely and freely, a notification to the remote device for many types of event.

### SUMMARY OF THE INVENTION

A general advantage of the present invention is to provide a document management device and a recording medium recording a document management program which can freely and precisely define and process a destination for notification to a remote device for the event that is generated in the document management device. An additional advantage of the present invention is to provide a document management device and a recording medium recording a document management program which can freely and precisely define a message to be notified to the remote device according to the type of the event. Another additional advantage of the present invention is to provide a document management device and a recording medium recording a document management program which can freely and precisely define a communication unit to the remote device according to the type of the event.

A document management device of the present invention includes a communication unit, a defining unit, a detecting unit, and a processing unit. The communication unit is a unit for communicating with a remote device. The defining unit defines several types of events relating to a communication or a document to be managed, as a combination of an event generation conditions and a destination of notification to a remote device. The detecting unit detects the generation of the event. The processing unit notifies the generated event to the destination of notification defined by the defining unit.

The defining unit can define a message to be notified to the destination of notification for each type of event. Moreover, the defining unit can define the communication unit for notifying to the destination of notification for each type of event.

A document management program recorded in a recording medium of the present invention is used in the document management device including a communication unit for communicating with a remote device. The document management program includes a storage command, a detection command, and a processing command. The storage command is a command for storing several types of events relating to a communication or a document to be managed, as a combination of an event generation condition and a destination of notification to a remote device. The detection command is a command for detecting the generation of the event. The processing command is a command for notifying the generated event to the destination of notification stored by the storage command.

The storage command can store a message for notifying to the destination of notification for each type of event. Moreover, the storage command can store the communication unit for notifying to the destination of notification for each type of event.

The document management device and the recording medium recording the document management program of the present invention can define and store the combination of the event generation condition and the destination of notification to the remote device, and the event relating to a communication such as a facsimile reception, or the event such as editing, canceling or the like of the document to be managed. In general meaning, a facsimile data is not a document. However, since the facsimile data is handled as the document when being managed by the document management server or the like, the facsimile data will be included in the document in this specification. Moreover, the combination of the event generation unit and the destination of notification to the remote device are stored for several types of events. Next, when the event occurs, the generation of event is detected, and notified to the stored destination of notification. Therefore, the destination of notification to the remote device can be defined freely and precisely for various events.

Moreover, according to an additional invention, the message to be notified can be defined or stored for each type of event. Therefore, the message can be defined freely and precisely according to the type of the event, and the remote device can classify and manage the notification by using the message.

Furthermore, the communication unit can be selected freely from an electronic mail, a communication following protocols such as a Hyper Text Transfer Protocol (HTTP) or a File Transfer Protocol (FTP), a facsimile or the like. Therefore, the notification can be carried out to various remote devices.

### BRIEF DESCRIPTION OF THE DRAWINGS

FIG. 1 is a block diagram of a document management device of an embodiment of the present invention.

FIG. 2 is a view schematically showing a flow of a processing at the document management device of the embodiment.

FIG. 3 is a view schematically showing a configuration of an event setting table of the embodiment.

FIG. 4 is a view showing a setting screen of an electronic mail event in the embodiment.

FIG. 5 is a view showing a setting screen of a message event in the embodiment.

FIG. 6 is a view showing a setting screen of a list event in the embodiment.

FIG. 7 is a view showing a setting screen of an event file in the embodiment.

### DETAILED DESCRIPTION OF THE PREFERRED EMBODIMENTS

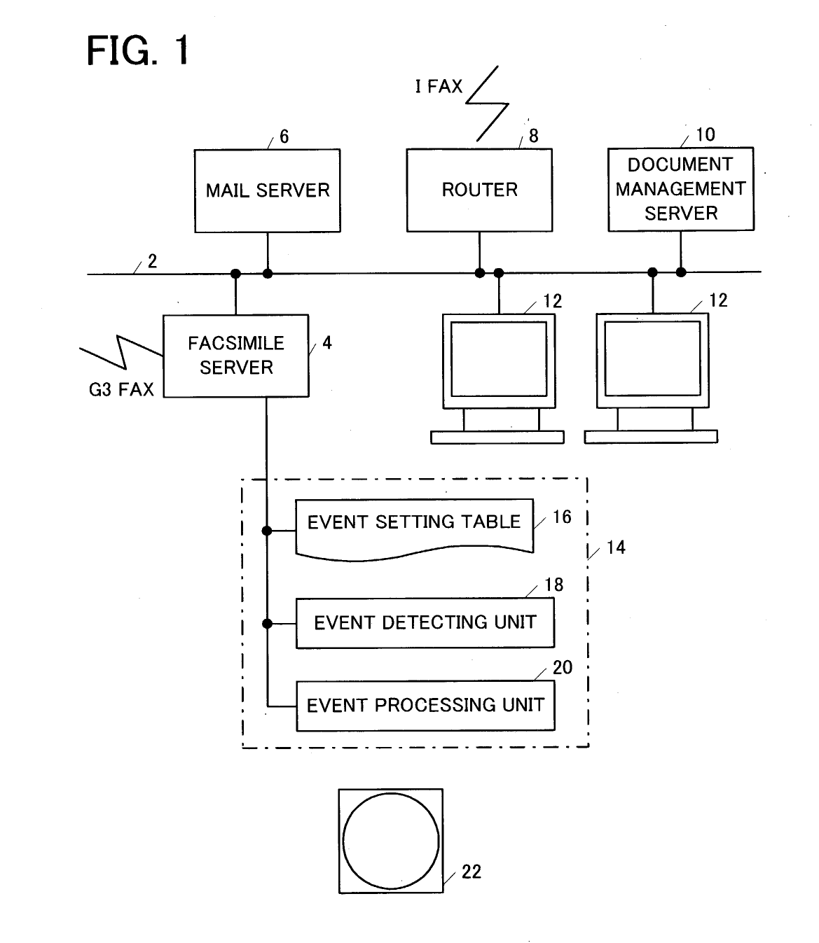

FIGS. 1 through 7 show an embodiment of the present invention. In the drawings, reference number 2 is a LAN, 4 is a facsimile server, 6 is a mail server, 8 is a router for connecting to a network such as the Internet, and 10 is a document management server. Reference number 12 is a client terminal. For example, the client terminal 12 can be a personal computer. The client terminal 12 requests various processing to the servers 4, 6, 10, and uploads a program or the like which is to be used by the servers.

The facsimile server 4 carries out a facsimile transmission and reception of G3 facsimile or the like via a public switched telephone network or the like. The facsimile server 4 also carries out a transmission and a reception of an Internet facsimile or the like via the mail server 6, the router 8 or the like. The facsimile server 4 includes a scanner function, a printer function, and a copy function. The facsimile server 4 is a server for inputting and outputting an image data for the LAN 2. A document management device 14 is provided to the facsimile server 4. The document management device 14 includes an event setting table 16, an event detecting unit 18, and an event processing unit 20. Since the document management device 14 itself does not include a communication unit, the document management device 14 uses the communication unit of the facsimile server 4 for a notification to a remote device. As described above, the document management device of the present invention is realized by adding a unique function of the facsimile server 4 to the document management device 14 of the present embodiment.

In the present embodiment, a facsimile reception is a generation of an event for the document management device 14. When the event occurs, the document management device 14 transmits a prescribed message to a remote device such as a prescribed terminal 12, which is defined in the event setting table 16, by a prescribed communication unit such as an electronic mail. Then, when the terminal requests a transferring of the facsimile, the request is handled as a generation of a new event, in other words, as a reference of the facsimile received original. Subsequently, such a fact is notified to the transmitter of the facsimile. Moreover, when trouble occurs, for example, when a memory overflow occurs or the received facsimile original is not referenced for a prescribed period of time or longer (even though a reception has been notified to a prescribed terminal, there is no request for transferring of the facsimile within a prescribed period of time), this fact is grasped as a matter necessary to be checked by a manager. This fact is notified to the terminal of the manager by a prescribed communication unit such as an electronic mail with a message attached according to the type of the event.

As described above, the document management device 14 handles the communication at the facsimile server 4, especially the facsimile reception or troubles such as a malfunction in the device, as a generation of the event. Then, the document management device 14 defines a destination of the notification, the communication unit, and the message for each type of event. When the event occurs, the document management device 14 references the defined content, and notifies of the occurrence of the event. An approach to the remote device such as the terminal within the LAN 2 from the facsimile server 4 including the document management device 14, is executed as the processing for the occurrence of the event.

Further, the document management device 14 can be provided in the document management server 10 or the like, and browsing, editing or deleting of the document managed by the document management server 10, an arrival of a new document for the document management server 10, or a transmission of a document from the document management server 10, can be managed as a generation of the event. In the case of the present embodiment, the document management device 14 operates by handling a reception of a facsimile data by the facsimile server 4, or a transfer and an output of the received facsimile data to the terminal 12 or the like, as the generation of the event.

The document management device 14 can be formed as software by storing in the facsimile server 4 or the like, a program stored in a recording medium 22. In this case, the document management program includes a command for storing an event generation condition, and a processing such as a destination of notification to the remote device to which the occurrence of the event is notified, the communication unit to be used, and a notification message. The document management program also includes a command for detecting an occurrence of the event. In addition, the document management program includes a processing command for processing a notification of a prescribed message by a prescribed communication unit to a stored destination when the event occurs. Further, the storage command is a command for storing the data corresponding to the event setting table 16.

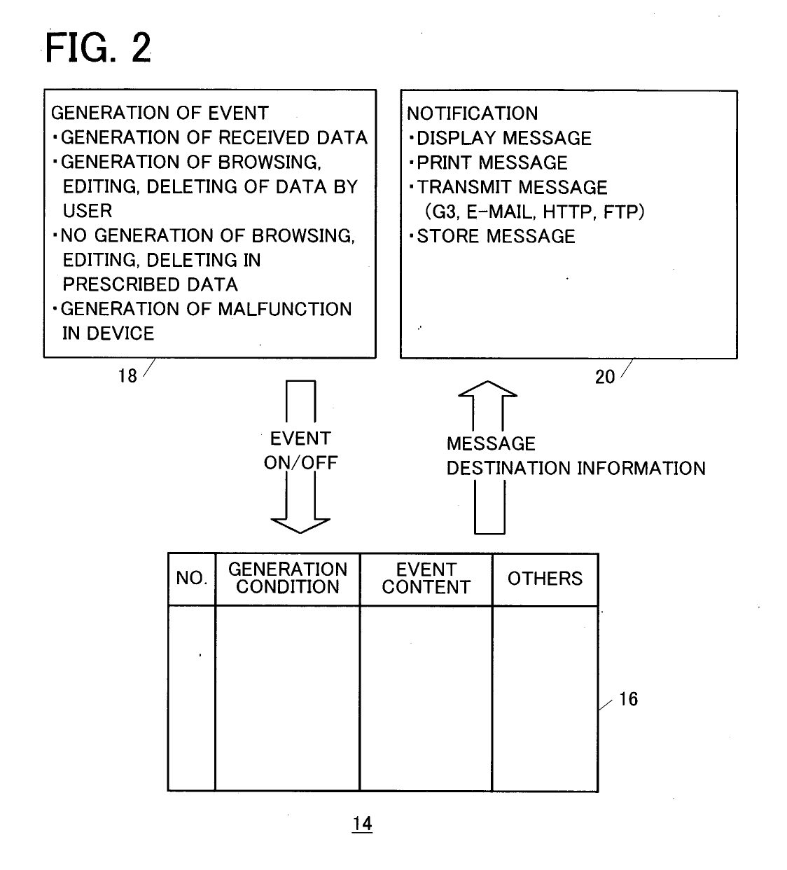

FIG. 2 shows a process from when an event occurs until the event is processed. Further, in FIG. 2, “generation of received data” means a reception of the facsimile data or the like. The reception of the facsimile data and a reception of a facsimile are synonyms. In the case of the document management server, “generation of received data” has a meaning of a reception of the document or the like. Moreover, “generation of browsing, editing, deleting of data by user” means that the received data has been referenced by the user, for example, by the received facsimile data being transferred to the terminal of the user. In the case of the document management server, “generation of browsing, editing, deleting of data by user” has a meaning that the data managed by the document management server has been accessed, for example, browsed, edited or deleted, by the user. Moreover, no generation of browsing, editing, deleting in prescribed data”, in the case of the facsimile server, means that the user did not reference the received facsimile data within a prescribed period of time. Moreover, in the case of the document management server, “no generation of browsing, editing, deleting in prescribed data” means that the user did not access to the data which is necessary to be accessed in some way within a prescribed period of time.

“Generation of malfunction in device” means a generation of a memory over or a generation of other malfunction in hardware or software. The content of the processing for the generated event is stored in the event setting table 16. The content of the processing for the event includes a notification of a prescribed message by a prescribed communication unit to a prescribed remote device or the like. The content of the processing for the event also includes displaying of the message on a display of the facsimile server, the document management server or the like. The content of the processing for the event also includes a printing of the message by using a printer function of the facsimile server 4. Furthermore, the generation status of the event and the processing for the generated event (destination of notification, communication unit, and message) can be stored and transferred to another document management device. Then, the other document management device that received the transferred generation status and processing can execute the processing.

The communication unit can be an electronic mail, or a file transfer by protocols such as the HTTP or the FTP. For the remote device which is not suitable for the file transfer or the electronic mail, the communication unit can be transmitted by G3 facsimile or the like. As described above, an appropriate communication unit can be defined for each of the remote devices to which the message is notified.

The content of the message can be defined freely according to the event generation condition (type of event). In addition, an appropriate message can be notified according to the event generation condition. As a result, the remote device which received the message can grasp the generation status of the event precisely. In addition, since the accumulated message can be classified according to a keyword or the like, the generation condition of the event or the message can be easily classified and managed.

The destination of notification can be an address in the LAN 2, an address such as a Uniform Resource Locator (URL) in the Internet, or a facsimile number in the G3 facsimile or the like. Further, “admin” is the address of the manager of the facsimile server. For example, when transmitting the message by the electronic mail, a mail address is to be the address of the destination of notification. The destination of notification, the communication unit, and the message can be defined for each event generation condition. Moreover, a plurality of communication units can be designated for one destination of notification.

For the type of the event, for example, a large concept like “reception of facsimile data” can be made as one type. On the contrary, the “reception of facsimile data” can be classified finely into a plurality of events and defined. When classifying finely and defining, for example, if “transmitter” or “designated final address” is different, the event can be defined as a different event. Without describing the destination of notification directly in the event setting table, the destination of notification can be defined indirectly by the event setting table. When defining the destination of notification indirectly, an extraction condition for the destination of notification can be described in the event setting table, and the described extraction condition can be referenced. Accordingly, the destination of notification can be extracted from the description of an address or the like included in the facsimile data.

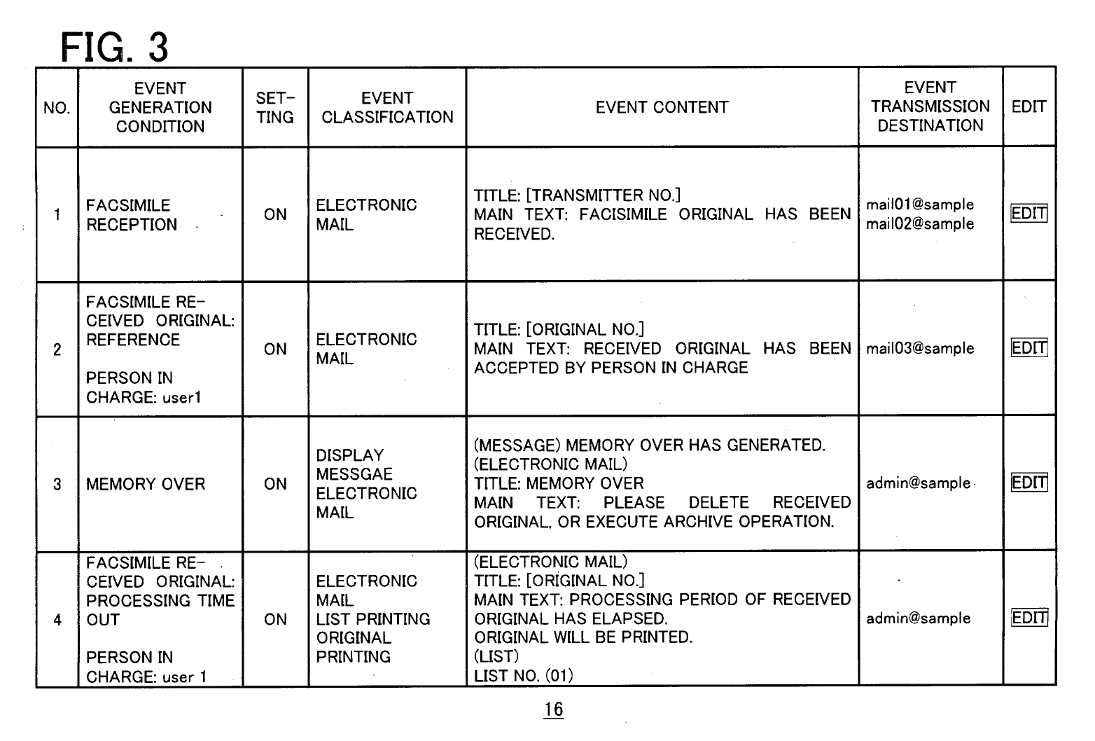

FIG. 3 shows an example of the event setting table 16. The number at the leftmost column is the event number. The event generation condition shows an event which generates the event. “ON” in the “setting” column means that when the event described in the event generation condition column generates, a notification or the like is carried out to the remote device. “OFF” in the “setting” column means that even when the event described in the “event generation condition” column occurs, a notification or the like to the remote device is not carried out.

“Event classification” column shows a classification of the communication unit to be used for the generation of the event or other processing to be carried out for the generation of the event. “Electronic mail” has a meaning of transmitting the message described in “event content” column by electronic mail. “Display message” means displaying the message on the display of the facsimile server or the like. “List printing” means printing a list number defined for each event and the message of the remark defined for each event by using the facsimile server or the like. “Original printing” means printing the received facsimile data or the like from the facsimile server.

“Event transmission destination” column shows the destination to which the message is transmitted. Plural types of communication units can be defined for one destination of transmission. “Edit” column at the rightmost column of FIG. 3 means that when the content of the event setting table is displayed on the terminal 12 or the like, if “edit” button is clicked, the column of the corresponding event becomes editable.

Further, in FIG. 3, only the electronic mail was shown as an example of the communication unit. The communication unit can be the communication by the HTTP, the FTP or the like, or the facsimile communication. Moreover, when the event defined in the “event generation condition” column generates, the message defined in the “event content” column is notified to the destination of notification defined in the “event transmission destination” column via the communication unit defined in the “event classification” column. Then, other processing is executed.

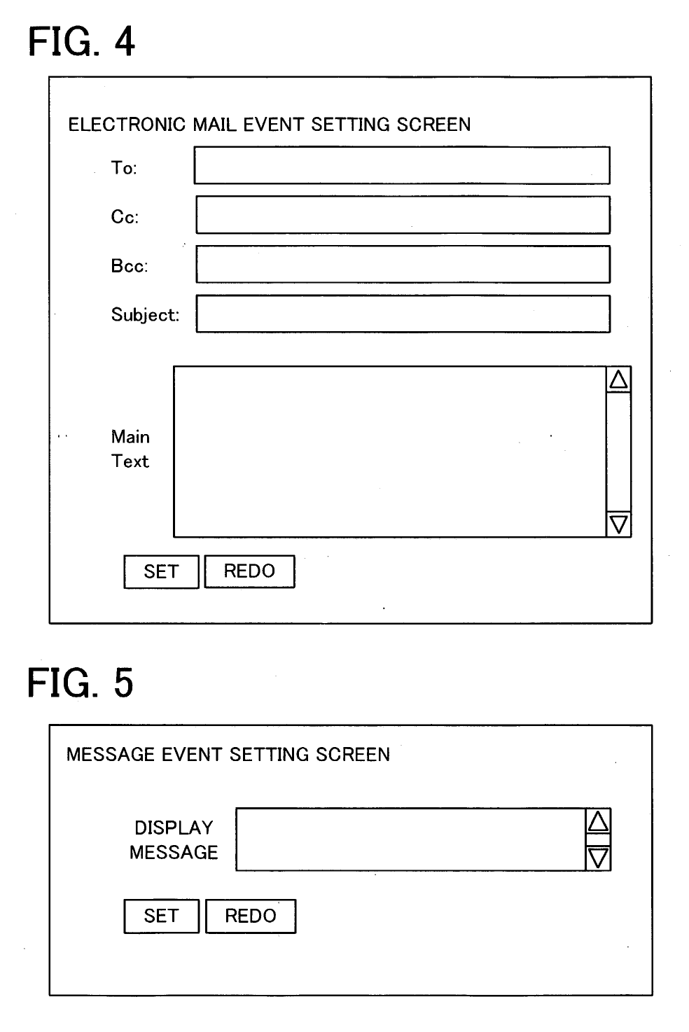

FIG. 4 through FIG. 7 show an example of the setting of the event setting table. In FIG. 4 through FIG. 7, it will be assumed that the event generation condition is already input. FIG. 4 shows a setting screen for when the event classification is the electronic mail, and is displayed on the terminal 12 or the like. The destination of the electronic mail, “To”, and the destination of a blind carbon copy, “Bcc” are set. In addition, “Subject” and “Main Text” of the electronic mail are set. When the input content is OK, “set” button is selected. When correction is necessary, “redo” button is selected.

FIG. 5 shows a setting screen for the message to be displayed at the message event. The setting screen shown in FIG. 5 is for setting the display message for when the event is to display the message on the display of the facsimile server or the like.

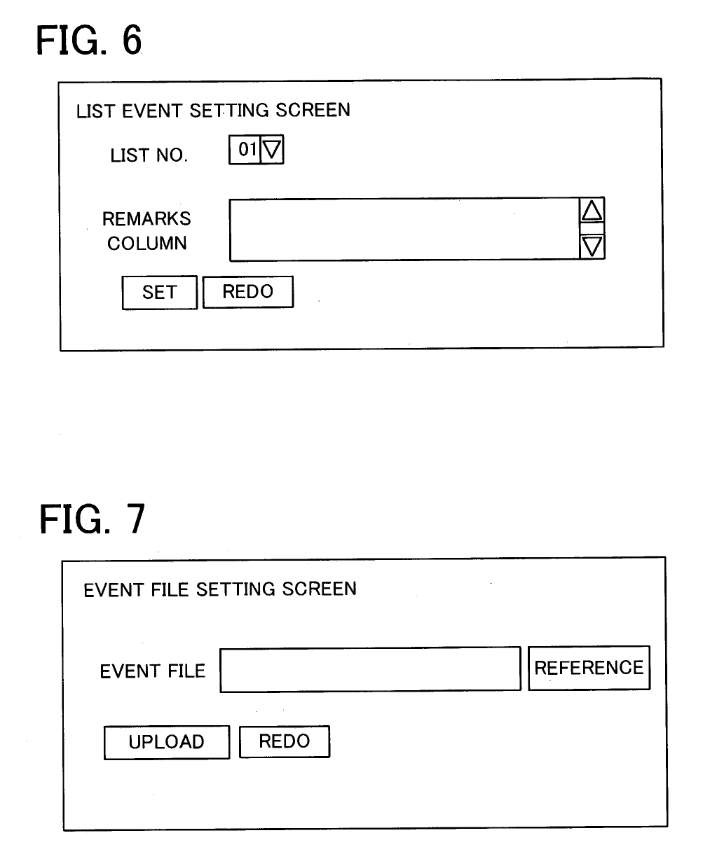

FIG. 6 shows the setting screen of the list event. The example shown in FIG. 6 defines the “list number” for each type of the event, such that the list number and the message in the remark column are printed. FIG. 7 is a setting screen of the event file.

In the facsimile server or the document management server in the present embodiment, the generation of the event such as the reception of the facsimile or the access to the document, which it is necessary to be notified to the remote device, is grasped as the generation of the event. Then, the processing defined in the event setting table is executed. Since the destination of notification, the communication unit, the content of the message or the like for the event generation condition can be defined freely and precisely, a remote notification function high in the degree of freedom can be realized. Furthermore, since the communication unit can be selected, notification can be carried out to any remote device substantially. Moreover, since the message can be defined, the remote device which receives the message can easily classify or manage the message.

What is claimed is:

1. A document management device comprising:
a communication means for carrying out a communication with a remote device;
a defining means for defining plural types of event relating to a communication or a document to be managed as a combination of an event generation condition and a destination of notification to the remote device;
a detecting means for detecting a generation of the event; and
a processing means for notifying the generated event to a destination of notification defined by the defining means.

2. The document management device according to claim 1, wherein the defining means can define a message to be notified to the destination of notification for each type of event.

3. The document management device according to claim 1, wherein the defining means can define the communication means for notifying to the destination of notification for each type of event.

4. The document management device according to claim 1, wherein the event includes a reception of a facsimile.

5. The document management device according to claim 1, wherein the event includes a request from a remote terminal to transfer a facsimile data.

6. The document management device according to claim 1, wherein the event includes a memory over.

7. The document management device according to claim 1, wherein the event includes a state in which the received facsimile data is not referenced for a prescribed period of time or more.

8. The document management device according to claim 1, wherein the event includes a state in which the received facsimile data is not referenced for a prescribed period of time or more even if a reception is notified to a prescribed remote terminal.

9. The document management device according to claim 1, wherein the event includes a transfer and an output of the received facsimile data to a remote terminal.

10. The document management device according to claim 1, wherein the event includes at least one of browsing, editing, or deleting for the document to be managed.

11. The document management device according to claim 3, wherein the communication means includes means for transmitting an electronic mail to a remote terminal.

12. The document management device according to claim 3, wherein the communication means includes means for carrying out a file transfer to a remote terminal by a Hyper Text Transfer Protocol (HTTP) and/or a File Transfer Protocol (FTP).

13. The document management device according to claim 3, wherein the communication means includes means for carrying out a G3 facsimile transmission to a remote terminal.

14. The document management device according to claim 1, wherein the defining means can define a plurality of communication means for one destination of notification.

15. The document management device according to claim 1, wherein the defining means can set whether or not to carry out a notification at a generation of the event individually for each event.

16. A recording medium recording a document management program to be used in a document management device including a communication means for communicating with a remote device, the document management program comprising:
a storage command for storing plural types of event relating to a communication or a document to be managed as a combination of an event generation condition and a destination of notification to the remote device;
a detecting command for detecting a generation of an event; and
a processing command for notifying the generated event to the destination of notification stored by the storage command.

17. The recording medium recording the document management program according to claim 16, wherein the storage command stores a message to be notified to the destination of notification for each type of the event.

18. The recording medium recording the document management program according to claim 16, wherein the storage command stores the communication means for notifying to the destination of notification for each type of the event.

19. The recording medium recording the document management program according to claim 16, wherein the storage command stores a plurality of communication means for one destination of notification.

20. The recording medium recording the document management program according to claim 16, wherein the storage command can store whether or not to carry out a notification when the event generates for each event individually.
